(19) United States
(12) Patent Application Publication
(10) Pub. No.: US 2003/0193387 A1
(43) Pub. Date: Oct. 16, 2003

(54) Multiple-value resistor network

(76) Inventor: Han-ping Chen, Saratoga, CA (US)

Correspondence Address: Han-ping Chen, P.O. Box 2871, Saratoga, CA, 95070, US

(21) Appl. No.: 10/119,005

(22) Filed: Apr. 10, 2002

(51) Int. Cl. H01C 1/01

(52) U.S. Cl. 338/320

(57) ABSTRACT

A method and apparatus provides resistor networks with two or more resistance values, which may accommodate different circuit configurations with a common circuit assembly. Also, the present invention provides a packaging method using multiple-value resistor networks as connecting and disconnecting mechanisms for the signal lines on the package.

### BACKGROUND OF THE INVENTION

This invention relates to resistor elements and resistor networks.

Electronic circuit modules sometimes contain resistor networks to incorporate multiple resistors of the same value.

A 64-bit memory module normally contains 16 resistor networks, each with 4 resistor elements with a value of 10 ohms.

In order to construct usable memory module packages with partially defective memory chips, the on-board resistors are required to have certain combinations of values.

Using 64 or 128 single individual resistors is certainly one way to accommodate this situation. However, the assembly process is more time consuming. It is also subject to certain limitation on the total number of onboard components.

Using different printed circuit boards for different configurations is another way to cope with the situation. However, the inventory and production control becomes quite complex.

### BRIEF SUMMARY OF THE INVENTION

This invention proposes a method and apparatus to generate resistor networks with multiple values.

This invention provides a method to accommodate different component configurations with a single printed-circuit board.

This invention further provides a method to simplify the manufacturing process of an electronic circuit module.

### BRIEF DESCRIPTION OF THE DRAWINGS

FIG. 1 is a diagram of a prior art resistor network.

FIG. 2 is a diagram of a prior art memory circuit block.

FIG. 3 is a diagram of a prior art memory module.

FIG. 4 shows a number of preferred embodiments of the present invention for a multiple-value resistor network.

FIG. 5 shows a preferred embodiment of the present invention for a memory circuit block.

FIG. 6 shows a preferred embodiment of the present invention for a memory module.

### DETAILED DESCRIPTION OF THE INVENTION

The present invention will be illustrated with some preferred embodiments.

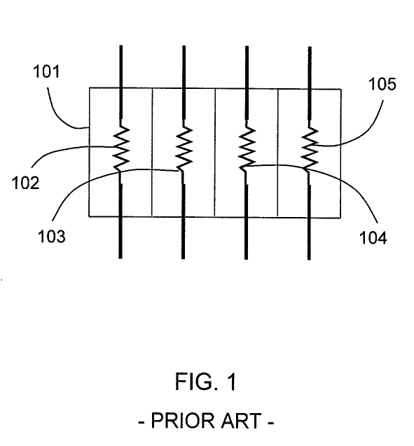

FIG. 1 is a diagram of a prior art resistor network. The resistor network 101 contains resistors 102, 103, 104, and 105. All four resistors are of the same value, for example, 10 ohms.

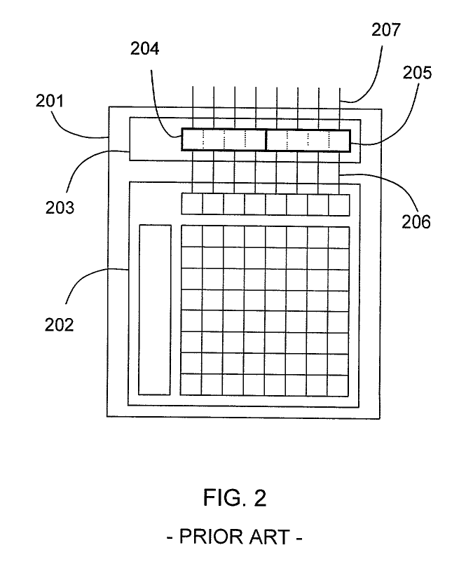

FIG. 2 is a diagram of a prior art memory circuit block. The memory circuit block 201 consists of a memory chip 202 and a resistor group 203. The resistor group contains two resistor networks 204 and 205.

Each resistor network contains 4 resistor elements of the same value, 10 ohms. A resistor element serves as a connecting mechanism to link a data bit line 206 on the memory chip to a data bit line 207 on the memory circuit block.

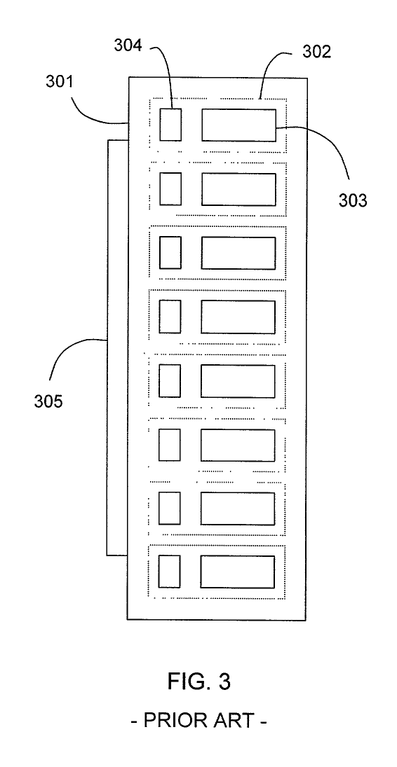

FIG. 3 is a diagram of a prior art memory module. The memory module 301 contains eight memory circuit blocks 302. A memory circuit block 302 consists of a memory chip 303 and a resistor group 304.

The resistors serve as connecting mechanisms to link the data bit lines on the memory chips to the data bit lines on the memory circuit blocks. The data bit lines on the memory circuit blocks are connected to the edge connector 305 of the memory module.

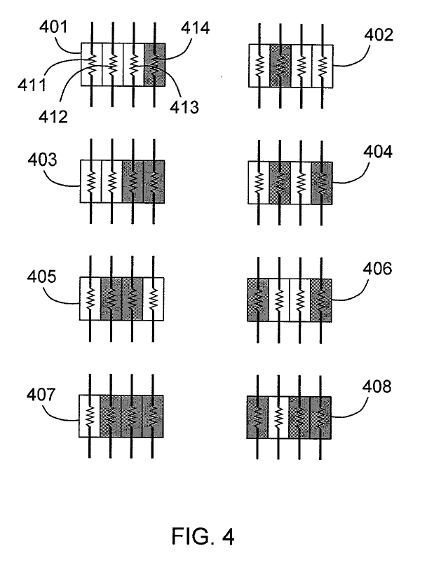

FIG. 4 shows a number of preferred embodiments of the present invention for a multiple-value resistor network.

The resistor network 401 contains resistors 411, 412, 413, and 414. The resistors 411, 412, and 413 are of one value, for example 10 ohms. The shaded resistor 414 has a different value, for example, 1 mega ohms.

FIG. 4 shows eight different combinations of multiple-value resistor networks with two different values. Shaded resistors are with a resistance value of 1 mega ohms. Blank resistors are with a resistance value of 10 ohms.

There are a total of 16 ways to combine four resistors with two possible values. Besides the eight combinations 401, 402, 403, 404, 405, 406, 407, and 408 shown in FIG. 4, six more combinations may be obtained by turning resistor networks 401, 402, 403, 404, 407, and 408 clockwise 180 degrees. The remaining two combinations contain only one resistance value, either 10 ohms or 1 mega ohms.

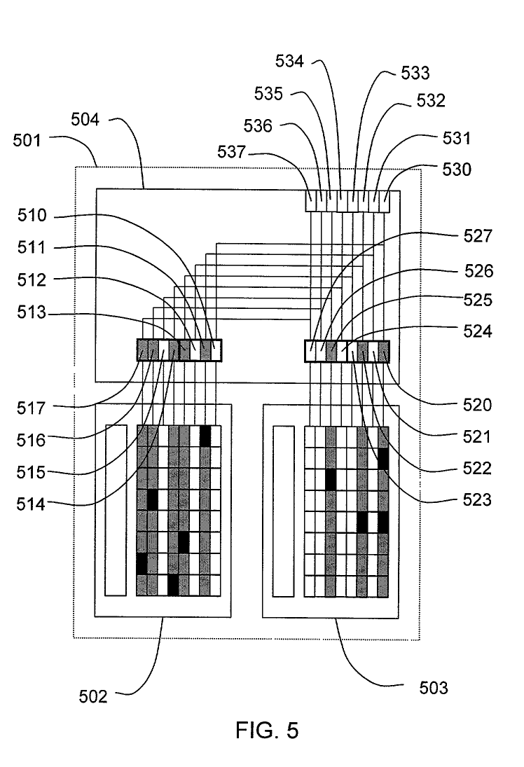

FIG. 5 shows a preferred embodiment of the present invention for a memory circuit block. The memory circuit block 501 consists of two memory chips 502, 503, and a resistor group 504. The resistor group contains four resistor networks, each with 4 resistors.

The resistors 510, 511, 512, 513, 514, 515, 516, and 517 link the data bit lines on the memory chip 502 to the memory bit lines 530, 531, 532, 533, 534, 535, 536, and 537 on the memory circuit block.

The resistors 520, 521, 522, 523, 524, 525, 526, and 527 link the data bit lines on the memory chip 503 to the memory bit lines 530, 531, 532, 533, 534, 535, 536, and 537 on the memory circuit block.

In memory chip 502, memory bit positions D1, D3, D4, D6, and D7 are marked as defective because they contain at least one defective memory blocks. The remaining bits D0, D2, and D5 contains only functional memory blocks.

Resistors 510, 512, and 515 with a low resistance value serve as connecting mechanisms to link the functional data bits D0, D2, and D5 to the data lines 530, 532, and 535 of the circuit block. Resistors 511, 513, 514, 516, and 517 with a high resistance value serve as disconnecting mechanisms to block D1, D3, D4, D6, and D7 from the circuit block data lines.

In memory chip 503, memory bit positions D0, D2, D5 are marked as defective because they contain at least one defective memory blocks. The remaining bits D1, D3, D4, D6, and D7 contains only functional blocks.

Resistors 521, 523, 524, 526, and 527 with a low resistance value serve as connecting mechanisms to link the functional data bits D1, D3, D4, D6, and D7 to the data line 531, 533, 534, 536 and 537 of the circuit block. Resistors 520, 522, and 525 with a high resistance value serve as disconnecting mechanisms to block D0, D2, D5 from the circuit block data lines.

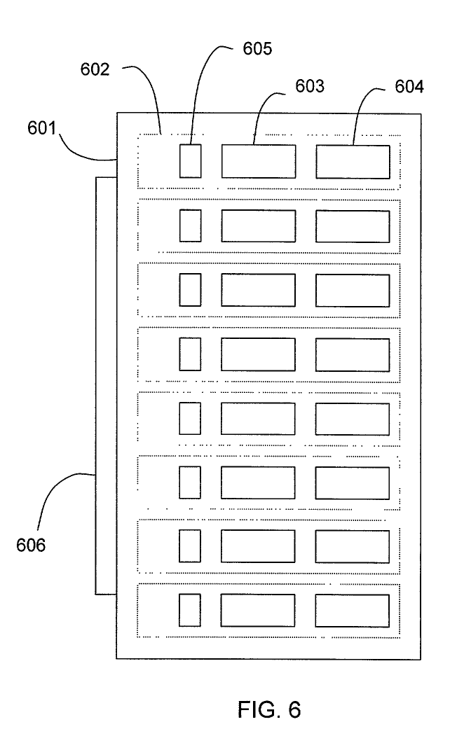

FIG. 6 shows a preferred embodiment of the present invention for a memory module. The memory module 601 contains eight memory circuit blocks 602. A memory circuit block 602 consists of two memory chips 603, 604, and a resistor group 605.

The resistors serve either as connecting mechanisms to link the functional chip data bit lines to the circuit block data bit lines or as disconnecting mechanisms to block the defective chip data bit lines from the circuit block data bit lines.

The data bit lines on the memory circuit blocks are connected to the edge connector 606 of the memory module.

I claim:

1. A resistor network package comprising:
(a) a plurality of external contact points;
(b) a plurality of first sub-packages each with a first resistance value between two external contact points;
(c) a plurality of second sub-packages each with a second resistance value between two external contact points;
wherein said first resistance value is different from said second resistance value;
wherein the difference between said first resistance value and said second resistance value is larger than 50% of the first resistance value.

2. The resistor network package of claim 1 wherein said first sub-package is a low-impedance material, a low-value resistor, a zero-ohm resistor, or a close-circuit connection.

3. The resistor network package of claim 1 wherein said second sub-package is a high-impedance material, a high-value resistor or an open-circuit condition.

4. An electronic circuit assembly comprising:
(a) a plurality of resistor network packages, at least one of which contains a first sub-package with a first resistance value between two external contact points and a second sub-package with a second resistance value between two external contact points, said second resistance value is different from the first resistance value by at least 50% of the first resistance value.
(b) a plurality of assembly signal lines;
(c) a circuit sub-assembly having a plurality of sub-assembly signal lines;
wherein at least one said sub-package in a resistor network package links one said sub-assembly signal line to one said assembly signal line.

5. The electronic circuit assembly of claim 4 wherein said first sub-package is a low-impedance material, a low-value resistor, a zero-ohm resistor, or a close-circuit connection.

6. The electronic circuit assembly of claim 4 wherein said second sub-package is a high-impedance material, a high-value resistor or an open-circuit condition.

7. An electronic circuit assembly comprising:
(a) a plurality of resistor network packages, at least one of which contains a first sub-package with a first resistance value between two external contact points and a second sub-package with a second resistance value between two external contact points, said second resistance value is different from the first resistance value by at least 50% of the first resistance value.
(b) a plurality of assembly signal lines;
(c) a first circuit sub-assembly having a plurality of first sub-assembly signal lines;
(d) a second circuit sub-assembly having a plurality of second sub-assembly signal lines;
wherein at least a first sub-package in a resistor network package links one said first sub-assembly signal line to a first said assembly signal line.
wherein at least a second sub-package in a resistor network package links one said second sub-assembly signal line to a second said assembly signal line.

8. The electronic circuit assembly of claim 7 wherein said first sub-package is a low-impedance material, a low-value resistor, a zero-ohm resistor, or a close-circuit connection.

9. The electronic circuit assembly of claim 7 wherein said second sub-package is a high-impedance material, a high-value resistor or an open-circuit condition.
